(19) United States
(12) Patent Application Publication
(10) Pub. No.: US 2026/0370457 A1
(43) Pub. Date: Nov. 19, 2026

(54) QUANTUM ARTIFICIAL INTELLIGENCE AND QUANTUM KEY DISTRIBUTION SYSTEMS

(71) Applicant: Bank of America Corporation, Charlotte, NC (US)

(72) Inventors: Vinesh Patel, London (GB); Michael Young, Davidson, NC (US); Manu Kurian, Dallas, TX (US)

(21) Appl. No.: 18/635,124

(22) Filed: Apr. 15, 2024

(51) Int. Cl. H04L 9/08; G06N 10/60

(52) U.S. Cl. CPC H04L 9/0852; G06N 10/60

(57) ABSTRACT

Methods for swapping digital assets using a quantum enabled system are provided. Methods may identify, at an artificial intelligence model operating on a quantum computing processor, one or more opportunities for asset exchange. The quantum computing processor may be linked to one or more asset exchanges via a first set of quantum key distribution methods. Methods may retrieve one or more assets from a digital warm wallet. A quantum encrypted firewall may interface between the wallet and the processor. Methods may use the retrieved assets to access and exchange a second set of one or more assets associated with the opportunities. The second set of assets may be linked, via a second set of quantum key distribution, to the one or more asset exchanges. Methods may replace the one or more assets and/or a benefit of the second set of one or more assets within the digital warm wallet.

### FIELD OF TECHNOLOGY

Aspects of the disclosure relate to quantum computing.

### BACKGROUND OF THE DISCLOSURE

Current communications are limited by the computing power and speed available in silicon-based computing systems. Quantum computing operates in a different manner than classical computing and therefore provides a significant increase in the amount of computing power and speed when compared to a classical computer. As an example, a classical computer with 100 bits can produce N number of outputs in T amount of time and a quantum computer with 100 qubits can produce, at times, at least N² number of outputs in T amount of time.

As such, it would be desirable to harness the capabilities of quantum computing, including quantum artificial intelligence and quantum key distribution, to identify and execute transaction opportunities.

### SUMMARY OF THE DISCLOSURE

Systems, apparatus and methods for a quantum enabled system may be provided. Systems may include and/or access a digital warm wallet. Systems may include a deep packet inspection-enabled, quantum encrypted firewall.

Systems may include a quantum computing processor. The quantum computing processor may be operable to access a plurality of assets via quantum key distribution methods. Each of the plurality of assets may be linked to an exchange via a second set of quantum key distribution methods. An exchange may be a platform for an exchange.

The quantum computing processor may access the digital warm wallet via the quantum encrypted firewall. The quantum computing processor may continuously monitor the plurality of assets to identify opportunities between one or more assets on one or more exchanges. The quantum computing processor may communicate with the warm wallet over the quantum encrypted firewall. The quantum computing processor may retrieve assets from the warm wallet. The quantum computing processor may use the retrieved assets to swap assets on the one or more exchanges.

It should be noted that time elapsed from identifying opportunities to swap assets on the one or more exchanges may be in a range of nanoseconds, picoseconds, femtoseconds and/or zeptoseconds.

The quantum key distribution methods may include a secure cryptographic protocol that enables two parties to share a random secret key that can be used to encrypt and decrypt transmissions between the assets and the exchanges. The two parties may be the one or more assets and the one or more exchanges. The two parties may be the quantum computing processor and the one or more assets.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows still another illustrative diagram in accordance with principles of the disclosure;

FIGS. 7A and 7B show an illustrative computer code segment in accordance with principles of the disclosure;

FIGS. 8A and 8B show another illustrative computer code segment in accordance with principles of the disclosure; and

FIG. 9 shows still another illustrative computer code segment in accordance with principles of the disclosure.

### DETAILED DESCRIPTION OF THE DISCLOSURE

Apparatus, methods, systems for a quantum system may be provided. The quantum system may include a quantum processor. The quantum processor may be operable to identify, in real-time, exchange opportunities on one or more of a plurality of exchanges. The quantum processor may utilize artificial intelligence to identify the exchange opportunities.

The exchange opportunities may include two exchanges in which a first asset on a first exchange is exchanged with a second asset on the second exchange. At times, the first asset may be the same asset as the second asset, however the price of the asset may be different on the first exchange and the second exchange.

The exchange opportunities may include three or more exchanges, in which a first asset on a first exchange may be exchanged with a second asset on a second exchange, and the second asset on the second exchange may be exchanged with a third asset on a third exchange and the third asset on the third exchange may be exchanged with a fourth asset on the first exchange.

The exchange opportunities may include three or more exchanges, in which a first asset on first exchange may be exchanged with a second asset on a second exchange, and the second asset on the second exchange may be exchanged with a third asset on a third exchange and the third asset on the third exchange may be exchanged with the first asset on the first exchange.

The quantum processor may manipulate or control one or more assets. The one or more assets may be accessible via one or more exchanges. The manipulation may involve a first level of quantum key distribution. The one or more assets may be accessible, via a second level of quantum key distribution, on the one or more exchanges.

The quantum system may also include a warm digital wallet. The warm digital wallet may be operable to store digital assets.

The quantum system may also include a quantum encrypted firewall. The quantum encrypted firewall may be operable to implement deep packet inspection. The deep packet inspection may ensure the reliability of network traffic between the quantum processor and the warm wallet. The deep packet inspection may ensure that communications between the warm digital wallet and the quantum processor are not being eavesdropped and/or compromised. The deep packet inspection may also ensure that no malicious packets are being transmitted to or from the warm digital wallet. The deep packet inspection may also perform traffic management between the quantum processor and the warm digital wallet.

The quantum encrypted firewall may be operable to interface between the warm digital wallet and the quantum processor.

The quantum processor may identify an exchange opportunity. The quantum processor may communicate with the warm digital wallet to exchange digital assets on one or more exchanges relevant to the exchange opportunity. The quantum processor may identify exchange opportunities to the closest nanosecond, picosecond, femtosecond and/or zeptosecond.

The quantum processor may be a node on a decentralized network.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

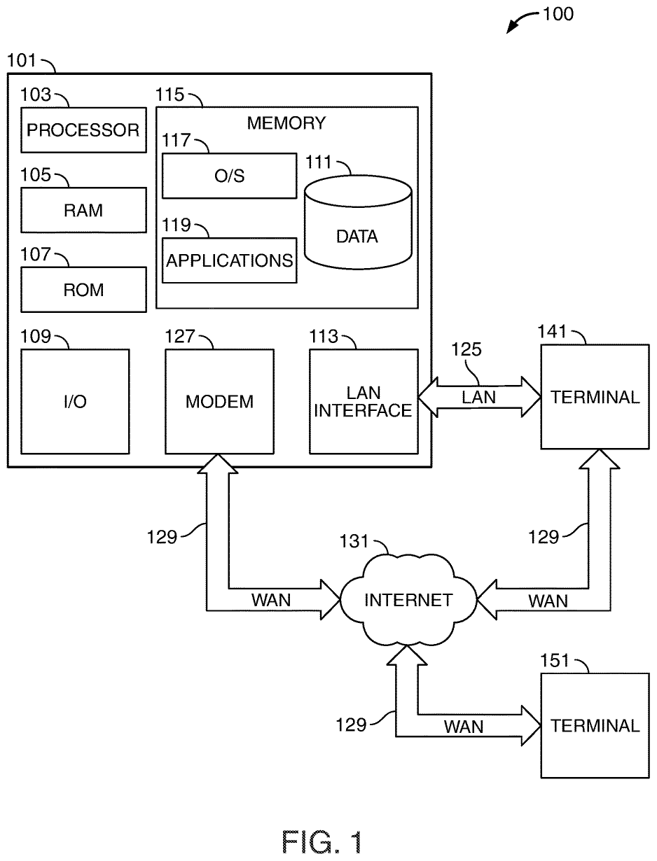

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the user telephones, mobile devices, user devices, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. Memory 115 may also store videos, text and/or audio assistance files. Nodes, servers, computing devices, user telephones, user devices, databases and any other suitable computing devices as disclosed herein may have one or more features in common with Memory 115. The data stored in Memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

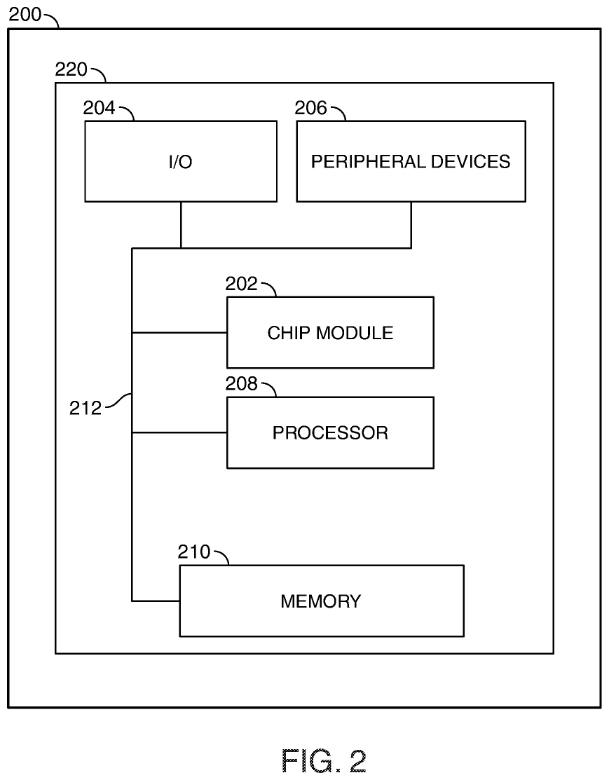

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

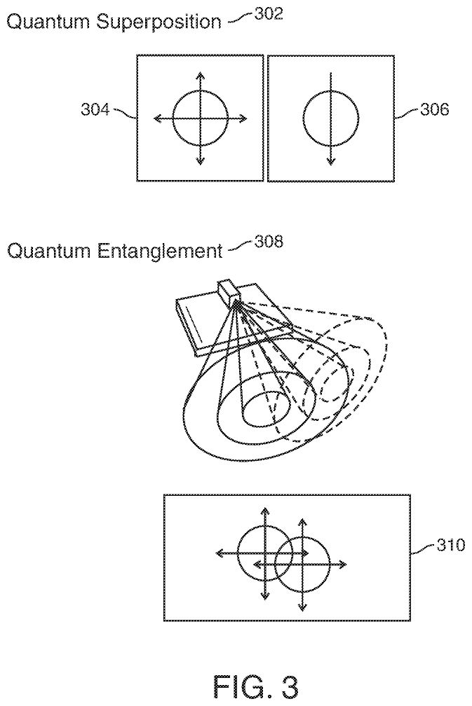

FIG. 3 shows an illustrative diagram. The illustrative diagram shows components of quantum technology. Because quantum technology behaves differently from classical technology, quantum technology provides additional facets to computing. While storage and computing capacity of classical computing grows in a linear fashion, storage and computing capacity of quantum computing grows in an exponential fashion.

Quantum technology may rely on properties of quantum mechanics, such as, for example, quantum superposition, quantum entanglement, quantum tunnelling and quantum interference.

Quantum superposition, shown at 302, states that an unobserved quantum particle, such as a photon, exists in all possible states (spin-up state, a spin-down state or any probability of a spin-up state and spin-down state) simultaneously, as shown at 304. However, when a quantum particle is observed or measured, the quantum particle collapses into a single state, such as a spin-down state, as shown at 306.

Quantum entanglement, shown at 308, states that quantum particles may become connected with one another. The entangled particles correlate with each other, as shown at 310. As such, even when the entangled particles are physically far apart, measuring the state of one of the entangled particles reveals the state of the other entangled particle.

A laser beam fired through a certain type of crystal can cause individual photons to be split into pairs of entangled photons. A pair of entangled photons may be shown at 308.

Quantum tunnelling states that a quantum particle may pass through a potential energy barrier that, according to classical physics, should not be passable due to the object not having sufficient energy to pass or surmount the barrier.

Quantum interference states that a quantum particle may interface with and/or influence itself and/or other particles while in a superposition state. Quantum interference can influence the probability of the state of the particle when the quantum particle is measured.

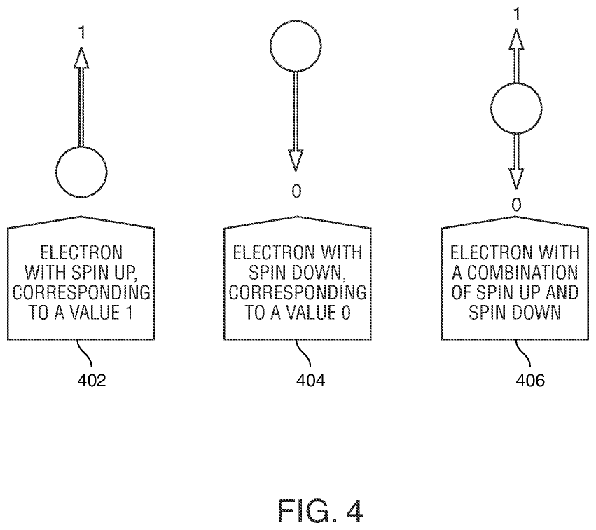

FIG. 4 shows an illustrative diagram. The illustrative diagram shows multiple electrons. A first electron, shown at 402, shows a spin-up, which may correspond, within a quantum processor, to a value of one. A second electron, shown at 404, shows a spin-down, which may correspond, within a quantum processor, to a value of zero. A third electron, shown at 406, shows a combination of a spin-up and a spin-down, which may correspond, within a quantum processor, to a value of both one and zero. A combination state of both spin-up and spin-down may be referred to as superposition.

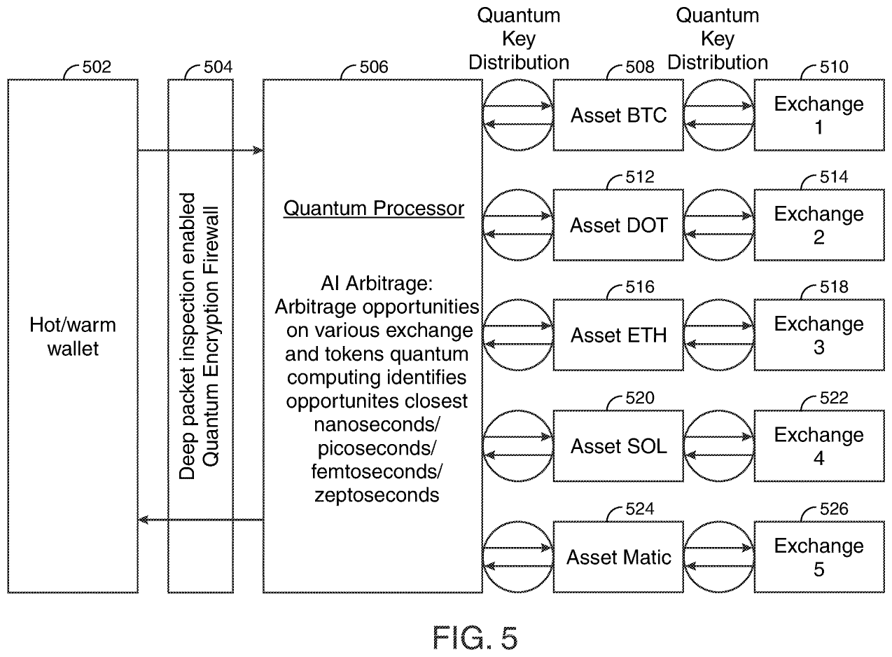

FIG. 5 shows another illustrative diagram. The illustrative diagram shows a quantum processor (506). Quantum processor 506 may reside on a node of decentralized network. Quantum processor 506 may interface with both warm wallet 502 and one or more assets (508, 512, 516, 520 and 524). Deep packet inspection enabled quantum encryption firewall 504 may interface between quantum processor 506 and digital wallet 502. Firewall 504 may secure assets included within digital wallet 502.

The one or more assets may be shown at 508, 512, 516, 520 and 524. The one or more assets may be accessible via one or more exchanges, shown at 510, 514, 518, 522 and 526. It should be noted that each of the exchanges may be able to access one or more or more assets. For example, exchange 1, shown at 510, may be able to access asset 508 and assets 512.

The communication between the quantum processor and the one or more assets may be protected by quantum key distribution. Quantum key distribution may secure communications in a quantum enabled communication system. As such, quantum key distribution may be referred to as a quantum resilient computing security. The one or more assets may include, for example, Bitcoin (BTC), Polkadot (DOT), Ethereum (ETH), Solana (SOL) and Polygon (Matic).

The communication between the one or more assets and the one or more exchanges may be protected by quantum key distribution. Each of the one or more assets may be traded using one or more exchanges (alternatively understood as exchange platforms), such as exchange 1, exchange 2, exchange 3, exchange 4 and exchange 5. The communications that enable the assets to be traded on one or more of the exchanges may also involve quantum key distribution.

It should be noted that the quantum key distribution in which the quantum processor communicates with the assets may be different from the quantum key distribution in which the assets are exchanged over one or more exchanges.

The quantum processor may identify exchange opportunities on the one or more exchanges. The exchange opportunities may be used to create arbitrage opportunities. The arbitrage opportunities may be between various exchanges and tokens. For example, a first asset, on a first exchange may cost $10.00 USD. The first asset on a second exchange may cost $10.05 USD. As such, it may be profitable to purchase the first asset on the first exchange and then immediately sell the first asset on the second exchange and then immediately buy the first asset on the first exchange. Such an arbitrage transaction may result in a profit of $0.05 USD.

It should be noted that quantum processors may be able to identify arbitrage opportunities at a much quicker speeds than classical processors. Therefore, using quantum processors in addition to artificial intelligence to identify the arbitrage opportunities may be an effective system. Additionally, the quantum processor may be able to perform one or more transactions, such as buying and/or selling assets, on the one or more exchanges within a short timeframe (nanoseconds/picoseconds/femtoseconds/zeptoseconds). A quantum processor that can both identify opportunities and execute the opportunities may be able to effectively profit from such opportunities.

At times, one or more assets may be stored within the warm wallet. The quantum processor may use one or more assets, included in the warm wallet, to purchase one or more assets on the one or more exchanges. Once the opportunity is complete, the additional assets may be placed in the warm wallet.

An opportunity may also include staking. Staking may be a process in which a node, on a decentralized network, may validate transactions on the blockchain network. Validator nodes may stake a number of tokens on a blockchain network in order to activate their ability to create new blocks. In blockchain networks that use proof of stake to validate a block, verification of transactions may be validated by a selected validator node. It should be noted that a validator node may be unable to move, or trade, the blocks that are being staked. The chance of being selected as a validator may be proportionate to the number of tokens staked by a node. A validator node may be selected. The selected validator node may confirm transactions and validate block information. The validator node may receive rewards for performing the validation. The rewards may include transaction fees and/or blocks.

At times, the quantum processor may use the assets in one or more warm wallets to provide a staking opportunity. For example, the quantum processor may combine multiple assets from multiple warm wallets to increase the chance of being selected as a validator node. In addition, the rewards earned by validating a transaction on the blockchain may be divided by the number of contributors, where each contributor receives a portion of the reward that corresponds to the portion of the number of staked blocks.

A hot wallet may be understood to mean a digital currency container that is connected to the internet and therefore connected to one or more exchanges. A hot wallet may enable seamless receipt and transmission of digital assets. A hot wallet may store many forms of digital assets. However, hot wallets may be vulnerable to compromise specifically because hot wallets are continuously connected to the internet.

A cold wallet may be understood to mean a digital currency container that does not connect to the internet when the container is not in use. A cold wallet may require connection to the internet in order to process transactions. Connection may be via universal serial bus (“USB”), wireless network protocol (“Wi-Fi”), quick response code (“QR”) code any other suitable connection. A cold wallet may be a storage device. The storage device may be configured to store private crypto keys. A cold wallet may be a physical wallet with a piece of paper that includes the private crypto keys.

Because a hot wallet continuously maintains connection to the internet and exchanges and because the hot wallet can be used to perform transactions, a hot wallet may have a greater exposure of being compromised by people of malicious intent.

Therefore, a warm wallet and/or hot/warm wallet may be used. A warm wallet may be a digital currency container that is linked to the quantum processor via a quantum resilient firewall with deep packet inspection. The warm wallet may not be directly connected to the internet. The quantum processor may sit in between the warm wallet and the plurality of assets, the plurality of exchanges and/or the internet. As such, the warm wallet may be a secure wallet, however, the contents of the warm wallet may be available to perform transactions.

The deep packet inspection capabilities of the quantum resilient firewall may ensure the reliability of network traffic between the quantum processor and the warm wallet. The deep packet inspection capabilities may also ensure that communications between the warm digital wallet and the quantum processor are not being eavesdropped (compromised) by a person of malicious intent. The deep packet inspection capabilities may also ensure that no malicious packets are being transmitted to or from the warm digital wallet. The deep packet inspection capabilities may also perform traffic management between the quantum processor and the warm wallet.

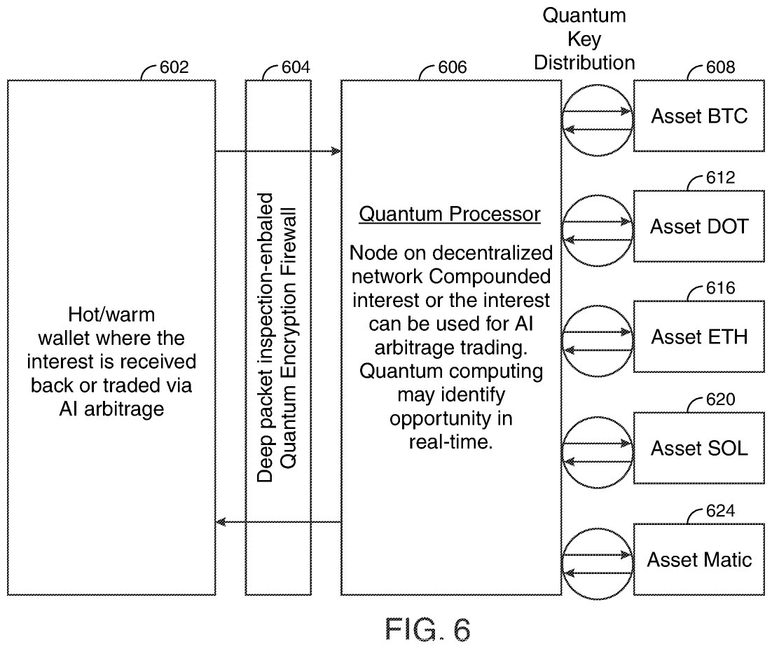

FIG. 6 shows another illustrative diagram. The illustrative diagram shows quantum processor 606 interfacing between a plurality of assets (assets 608, 612, 616, 620 and 624) and warm wallet 602. It should be noted that the once an opportunity has been completed, the profit or benefit may be transferred into warm wallet 602. Deep packet inspection enabled quantum encryption firewall may protect warm wallet 602 and therefore protect the assets stored within warm wallet 602.

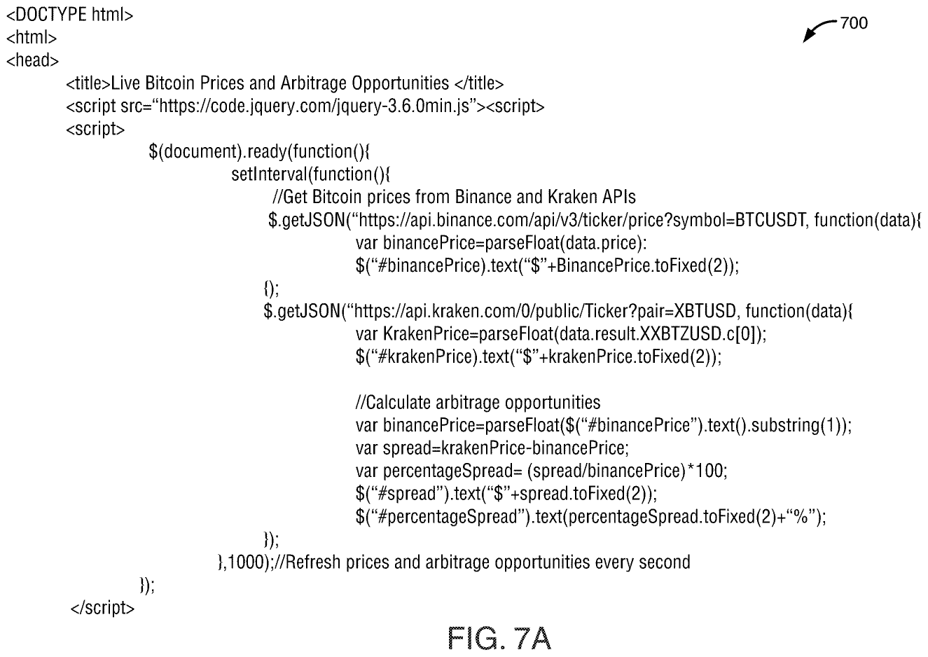

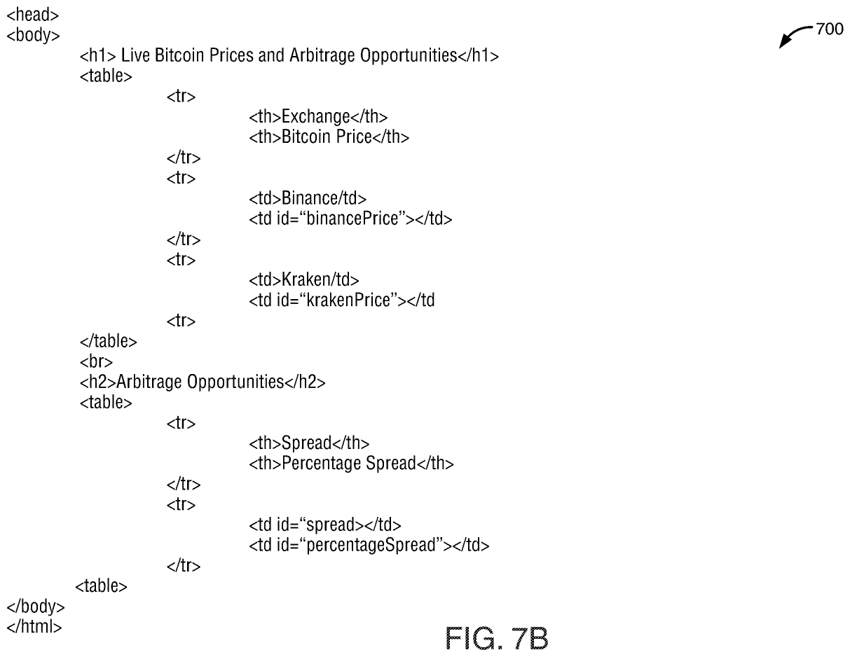

FIGS. 7A and 7B show illustrative computer code segment 700. Illustrative computer code segment 700 begins on FIG. 7A and continues onto FIG. 7B. The illustrative computer code segment may show an opportunity. The opportunity may be identified by artificial intelligence (“AI”) executing in tandem with a quantum processor. The illustrative computer code may retrieve Bitcoin prices associated with the following exchanges: Kraken and Binance. Both Kraken and Binance may be exchanges on which Bitcoin may be transferred. It should be noted that prices and associated opportunities may be refreshed at least every second.

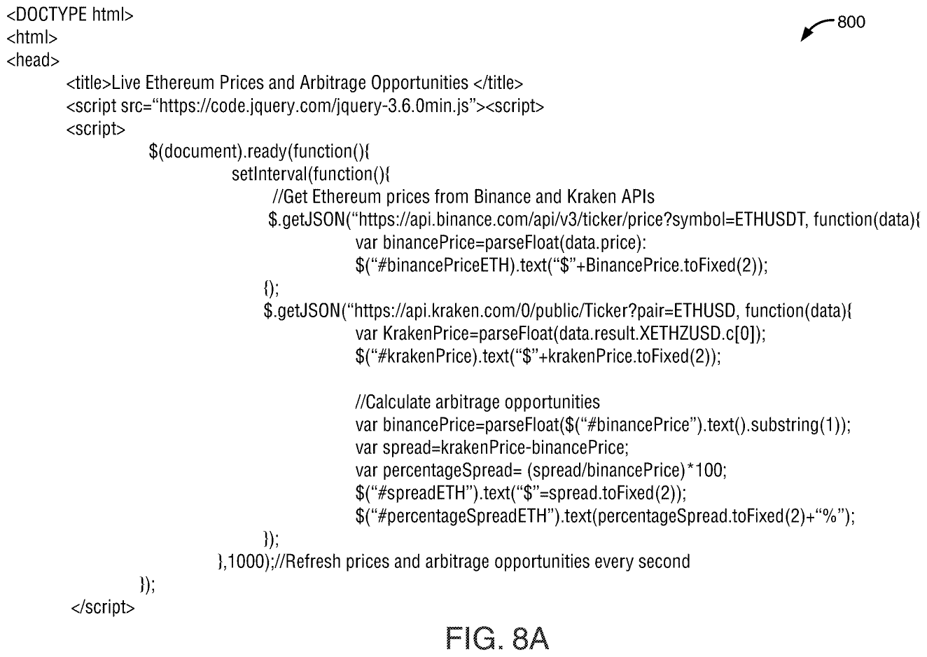

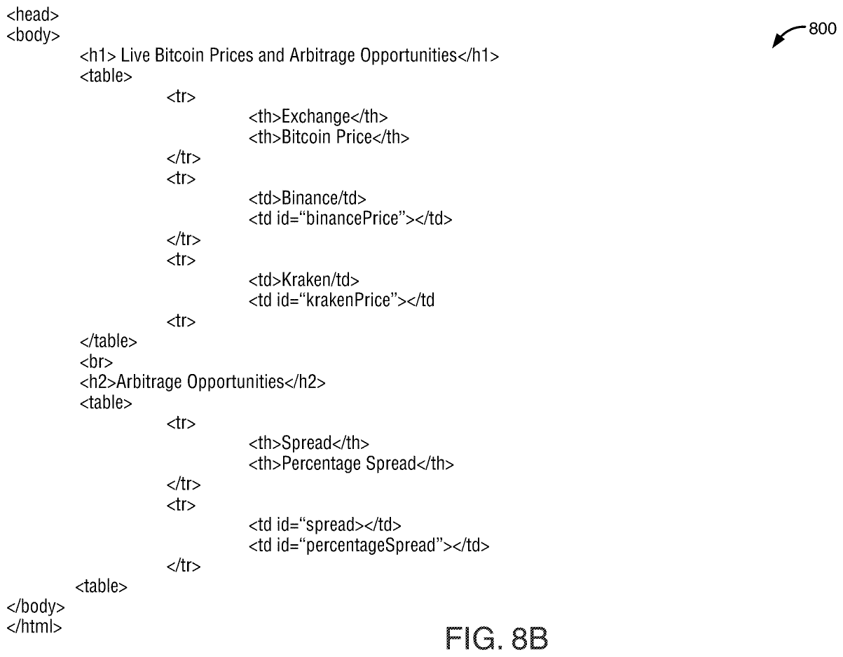

FIGS. 8A and 8B show illustrative computer code segment 800. Illustrative computer code segment 800 begins on FIG. 8A and continues onto FIG. 8B. The illustrative computer code segment may show an opportunity. The opportunity may be identified by AI executing in tandem with a quantum processor. The illustrative computer code may retrieve Ethereum prices associated with the following exchanges: Kraken and Binance. Both Kraken and Binance may be exchanges on which Ethereum may be transferred.

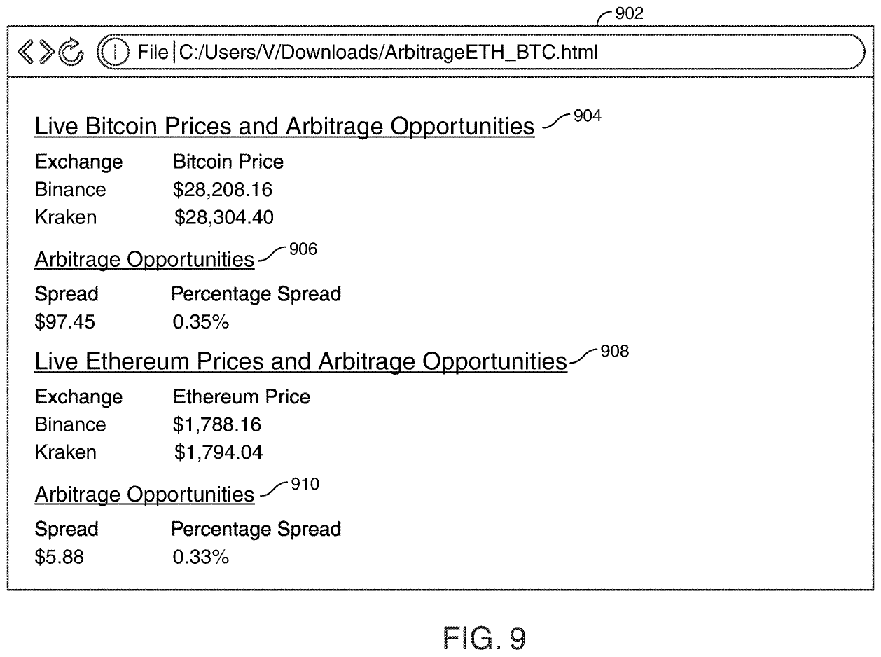

FIG. 9 shows another illustrative computer code segment. Illustrative computer code segment may be displayed on webpage 902. Code segments 904 and 906 may show the output of the computer code segment displayed on FIGS. 7A and 7B. Code segments 908 and 910 may show the output of the computer code segment displayed on FIGS. 8A and 8B.

Webpage 902 may show that there may be an arbitrage opportunity, in which one may buy Bitcoins via the Binance exchange and sell the Bitcoins on the Kraken exchange, thereby profiting $97.45 USD per buy and sell. The percentage spread may be 0.35%.

Code segment 904 may show that there may be an arbitrage opportunity, in which one may buy Ethereum via the Binance exchange and sell the Ethereum on the Kraken exchange, thereby profiting $5.88 USD per buy and sell. The percentage spread may be 0.33%.

Thus, systems and methods for quantum artificial intelligence and quantum key distribution systems are provided. Persons skilled in the art will appreciate that the present invention can be practiced by other than the described embodiments, which are presented for purposes of illustration rather than of limitation. The present invention is limited only by the claims that follow.

What is claimed is:

1. A quantum system comprising:
a quantum processor operable to:
identify, using artificial intelligence, in real-time, exchange opportunities on one or more of a plurality of exchanges;
manipulate, via a first level of quantum key distribution, one or more assets, said one or more assets accessible, via a second level of quantum key distribution, to one or more exchanges;
a warm digital wallet operable to:
store digital assets;
a quantum encrypted firewall operable to:
implement deep packet inspection; and
interface between the warm digital wallet and the quantum processor; wherein:
the quantum processor identifies an exchange opportunity; and
the quantum processor communicates with the warm digital wallet to exchange digital assets on one or more exchanges relevant to the exchange opportunity.

2. The quantum system of claim 1 wherein the quantum processor identifies exchange opportunities to the closest nanosecond, picosecond, femtosecond and/or zeptosecond.

3. The quantum system of claim 1 wherein the quantum processor is a node on a decentralized network.

4. The quantum system of claim 1 wherein the deep packet inspection ensures reliability of network traffic between the quantum processor and the warm digital wallet.

5. The quantum system of claim 1 wherein the deep packet inspection ensures that communications between the warm digital wallet and the quantum processor are not being eavesdropped.

6. The quantum system of claim 1 wherein the deep packet inspection ensures that no malicious packets are being transmitted to or from the warm digital wallet.

7. The quantum system of claim 1 wherein the deep packet inspection performs traffic management between the quantum processor and the warm digital wallet.

8. The quantum system of claim 1 wherein the exchange opportunities may include three or more exchanges, in which a first asset on a first exchange may be exchanged with a second asset on a second exchange, and the second asset on the second exchange may be exchanged with a third asset on a third exchange and the third asset on the third exchange may be exchanged with a fourth asset on the first exchange.

9. The quantum system of claim 1 wherein the exchange opportunities may include three or more exchanges, in which a first asset on a first exchange may be exchanged with second an asset on a second exchange, and the second asset on the second exchange may be exchanged with a third asset on a third exchange and the third asset on the third exchange may be exchanged with the first asset on the first exchange.

10. A quantum enabled system comprising:
a digital warm wallet;
a deep packet inspection-enabled, quantum encrypted firewall;
a quantum computing processor, said quantum computing processor operable to:
access a plurality of assets via quantum key distribution methods, each of the plurality of assets linked to an exchange via a second set of quantum key distribution;
access the digital warm wallet via the quantum encrypted firewall;
continuously monitor the plurality of assets to identify opportunities between one or more assets on one or more exchanges;
communicate with the warm wallet over the quantum encrypted firewall;
retrieve assets from the warm wallet; and
use the retrieved one or more assets to swap assets on the one or more exchanges.

11. The quantum enabled system of claim 10 wherein time elapsed from identifying opportunities to swap assets on the one or more exchanges is in a range of nanoseconds, picoseconds, femtoseconds and/or zeptoseconds.

12. The quantum enabled system of claim 10 wherein the quantum key distribution comprises a secure cryptographic protocol that enables two parties to share a random secret key that can be used to encrypt and decrypt transmissions between the assets and the one or more exchanges.

13. A method for swapping digital assets using a quantum enabled system, the method comprising:
identifying, at an artificial intelligence model operating on a quantum computing processor, one or more opportunities for asset exchange, said quantum computing processor linked to one or more asset exchanges via a first set of quantum key distribution methods;
retrieving one or more assets from a digital warm wallet, said digital warm wallet secured by a quantum encrypted firewall, said quantum encrypted firewall interfacing between the digital warm wallet and the quantum computing processor;
using the retrieved assets to access and exchange, a second set of one or more assets associated with the one or more opportunities, said second set of one or more assets linked, via a second set of quantum key distribution, to the one or more asset exchanges; and
replacing the one or more assets and/or a benefit of the second set of one or more assets within the digital warm wallet.

14. The method of claim 13, wherein the identifying occurs in real-time, to the closest nanoseconds, picoseconds, femtoseconds and/or zeptoseconds.

15. The method of claim 13, wherein the identifying occurs continuously.

16. The method of claim 13 wherein the first set of quantum key distribution comprises a secure cryptographic protocol that enables the quantum computing processor and the one or more asset exchanges to share a random secret key that can be used to encrypt and decrypt transmissions between the assets and the one or more exchanges.

17. The method of claim 13 wherein the second set of quantum key distribution comprises a secure cryptographic protocol that enables the one or more assets and the one or more asset exchanges to share a random secret key that can be used to encrypt and decrypt transmissions between the assets and the one or more exchanges.
